(19) United States
(12) Patent Application Publication
(10) Pub. No.: US 2011/0205133 A1
(43) Pub. Date: Aug. 25, 2011

(54) NON-CONTACT COMMUNICATION DEVICE

(75) Inventor: Toshinori Fukasawa, Kanagawa (JP)

(73) Assignee: PANASONIC CORPORATION, Osaka (JP)

(21) Appl. No.: 13/124,528

(22) PCT Filed: Jun. 23, 2009
(86) PCT No.: PCT/JP2009/002879

§ 371 Date: Apr. 15, 2011

(30) Foreign Application Priority Data
Oct. 17, 2008 (JP) 2008-268899

(51) Int. Cl. H01Q 1/00

(52) U.S. Cl. 343/745

(57) ABSTRACT

A problem of the invention is to provide a non-contact communication device capable of conducting non-contact communication even when a control section cannot be operated a drop in a battery voltage or a reset. A memory element (15) for storing resonance frequency adjustment data and communication condition data, and a setting register (2) capable of temporarily holding the resonance frequency adjustment data and the communication condition data from the memory element (15) to the setting register (2) before a reset by a CPU (17). When the CPU (17) is reset by a CPU reset signal, the resonance frequency adjusting data downloaded to the setting register (2) are used to adjust the resonance frequency of an antenna circuit. Thus, non-contact communication can be performed even when the CPU cannot operate because of a drop in the battery voltage or a reset.

### TECHNICAL FIELD

The present invention relates to a non-contact communication device suitable for use in a mobile telephone.

### BACKGROUND ART

In recent years, the needs that user uses trains by using a non-contact communication function mounted in a mobile telephone have increased. A non-contact communication method is disclosed in, for example, Patent Reference 1.

FIG. 3 is a block diagram showing a schematic configuration of a conventional non-contact communication device mounted in a mobile telephone capable of non-contact communication. A non-contact communication device 9 shown in FIG. 3 includes an antenna circuit 10, a resonance frequency adjusting circuit 11, a wireless circuit 12, a non-contact communication circuit 13, memory elements 14 and 15, a reset circuit 16, and a CPU 17. The antenna circuit 10 is configured by one coil L, plural capacitors C1 to Cn, and plural switches SW1 to SWn. The switches SW1 to SWn are inserted in series with the capacitors C2 to Cn. That is, the one capacitor C is configured to be connected in series with the one switch SW. A parallel resonance circuit with different resonance frequencies can be constructed together with the coil L and the capacitor C1 by turning on and off each of the switches SW1 to SWn.

A resonance frequency f0 of the antenna circuit 10 can be obtained from the following formula.

f0=1 /[2π√L×(C1+C2+C3+. . . Cn)]

The resonance frequency of the antenna circuit 10 is adjusted by the resonance frequency adjusting circuit 11. The resonance frequency adjusting circuit 11 sets the resonance frequency of the antenna circuit 10 by turning on and off the switches SW1 to SWn of the antenna circuit 10 based on resonance frequency adjustment data held in the memory element 14. The wireless circuit 12 demodulates received data from a wireless signal received by the antenna circuit 10, and the demodulated received data is inputted to the non-contact communication circuit 13 and also, by modulating carrier waves by send data inputted from the non-contact communication circuit 13, a wireless signal is generated and is sent from the antenna circuit 10. The non-contact communication circuit 13 conducts communication according to communication condition setting A and communication condition setting B set by the CPU 17. The memory element 14 holds the resonance frequency adjustment data as described above. In addition, EEPROM is generally used as the memory element 14.

The memory element 15 holds CPU control software (including communication condition data). The CPU 17 is operated according to the CPU control software held in the memory element 15, and sets the communication condition setting A and the communication condition setting B based on the communication condition data with respect to the non-contact communication circuit 13. The reset circuit 16 monitors a battery voltage, and resets the CPU 17 and the memory element 14 when the battery voltage drops to a predetermined value or less.

Next, an operation of the non-contact communication device 9 configured as described above will be described with reference to a time chart shown in FIG. 4. In FIG. 4, (a), (b), (c), (d), (e), (f) and (g) show the battery voltage, a state of attaching and detaching a battery, a state of CPU reset/reset release, a state of a holding region of the resonance frequency adjustment data, a state of an operation region of the non-contact communication device, a state of a writable region and a state of a readable region, respectively. A threshold value Th1 of CPU reset release and a threshold value Th2 of CPU reset with respect to the battery voltage are set in the non-contact communication device 9. A magnitude relation between the threshold values is Th1>Th2.

Now, when the battery is attached in a state that the battery (not shown) is detached, the present battery voltage is applied to the non-contact communication device 9 from time t1 at which the battery is attached. In the case of assuming that an AC adapter (not shown) is connected at this time, charging is started and the battery voltage rises. Thereafter, when the battery voltage exceeds the threshold value Th1 of the CPU reset release at time t2, the CPU reset is released and the CPU 17 becomes active. Also, together with the CPU reset release, the resonance frequency adjustment data can be read from the memory element 14 and further writing and readout by non-contact communication are enabled. Here, the writing by non-contact communication means that, for example, data is written on a ticket checker (not shown). Also, the readout by non-contact communication means that data is read from the ticket checker.

When the device only operates on the battery in a state that the AC adapter is disconnected and a load increases due to a telephone call etc. in operation on the battery and the battery voltage drops temporarily and falls below the threshold value Th2 of the CPU reset, the CPU is reset at the time t3 and the CPU 17 becomes inactive. Also, together with the CPU reset, the resonance frequency adjustment data cannot be read from the memory element 14. Further, writing and readout by non-contact communication are disabled. These states continue until a high-load operation such as the telephone call ends and the battery voltage exceeds the threshold value Th1 of the CPU reset release. When the high-load operation such as the telephone call ends and the battery voltage exceeds the threshold value Th1 of the CPU reset release, the CPU 17 becomes active at the time t4 and also the resonance frequency adjustment data can be read from the memory element 14. Further, writing and readout by non-contact communication are enabled.

Thereafter, when the battery voltage drops by battery discharging and falls below the threshold value Th2 of the reset, in a manner similar to the above, the CPU is reset at the time t5 and the CPU 17 becomes inactive. Also, together with the CPU reset, the resonance frequency adjustment data cannot be read from the memory element 14. Further, writing and readout by non-contact communication are disabled. Thereafter, when the AC adapter is connected and charging is again performed and the battery voltage exceeds the threshold value Th1 of the CPU reset release at time t6, the CPU 17 becomes active and also the resonance frequency adjustment data can be read from the memory element 14. Further, the non-contact communication device 9 can operate, and writing and readout by non-contact communication are enabled.

On the other hand, when the battery is detached, immediately after the detached time t7 (time t8), the battery voltage falls below the threshold value Th2 of the reset and in a manner similar to the above, the CPU is reset and the CPU 17 becomes inactive and also, the resonance frequency adjustment data cannot be read from the memory element 14. Further, writing and readout by non-contact communication are disabled.

### Prior Art Reference

### Patent Reference

Patent Reference 1: JP-A-2002-325051

### DISCLOSURE OF THE INVENTION

Problems that the Invention is to Solve

Incidentally, in the case of using trains by using a mobile telephone in which the non-contact communication function as described above is mounted, even when the CPU is reset (that is, an inactive state of the CPU) by a factor in, for example, a temporary drop in the battery voltage, it is necessary for a user to be able to pass through a ticket gate. However, in the conventional non-contact communication device described above, as is evident from the operation at the time t3 to t4 of FIG. 4, when the load increases temporarily due to the telephone call etc. and the battery voltage drops, the CPU 17 becomes inactive and also the resonance frequency adjustment data cannot be read from the memory element 14 and further the writing and readout by non-contact communication are disabled, so that the user cannot pass through the ticket gate. That is, there is a problem that the non-contact communication cannot be conducted in a state in which the load increases temporarily and the battery voltage drops and the CPU cannot operate.

The invention has been implemented in view of such circumstances, and an object of the invention is to provide a non-contact communication device capable of conducting non-contact communication even in a state in which a CPU cannot operate due to reset, a drop in a battery voltage, etc.

### Means for Solving the Problems

According to the present invention, there is provided a non-contact communication device which is driven by a battery and conducts non-contact communication by adjusting a resonance frequency of an antenna circuit using data for resonance frequency adjustment, the non-contact communication device comprising:

a memory section that stores the data for resonance frequency adjustment;

a control section that is reset by a first reset signal issued at the time when a voltage of the battery falls below a first threshold value;

a register section that temporarily holds data and is reset by a second reset signal issued at the time when the voltage of the battery falls below a second threshold value lower than the first threshold value; and

the antenna circuit whose resonance frequency is adjusted by the data temporarily held in the register section,

wherein the control section downloads the data for resonance frequency adjustment from the memory section to the register section as the data before the control section is reset by the first reset signal, and the resonance frequency of the antenna circuit is adjusted using the data for resonance frequency adjustment previously downloaded to the register section in a state that the control section is reset by the first reset signal.

According to the configuration described above, the data for resonance frequency adjustment is downloaded to the register section before the control section is reset by the first reset signal, and the resonance frequency of the antenna circuit is adjusted by using the data for resonance frequency adjustment downloaded to the register section in a state that the control section is reset by the first reset signal, so that non-contact communication can be conducted even in a state that the control section cannot be operated due to a drop in the battery voltage or reset when the non-contact communication device of the invention is applied to, for example, a mobile telephone.

Also, in the above configuration, the antenna circuit has a coil, a plurality of capacitors and a plurality of switches respectively connected to the plurality of capacitors, the resonance frequency of the antenna circuit is adjusted by turning on and off the plurality of switches using the data for resonance frequency adjustment.

### Advantage of the Invention

The invention can conduct the non-contact communication even in the state that the control section cannot be operated due to the drop in the battery voltage or the reset.

### BRIEF DESCRIPTION OF THE DRAWINGS

FIG. 1 is a block diagram showing a schematic configuration of a non-contact communication device according to one embodiment of the invention.

FIG. 2 is a time chart describing an operation of the non-contact communication device of FIG. 1.

FIG. 3 is a block diagram showing a schematic configuration of a conventional non-contact communication device.

FIG. 4 is a time chart describing an operation of the conventional non-contact communication device of FIG. 3.

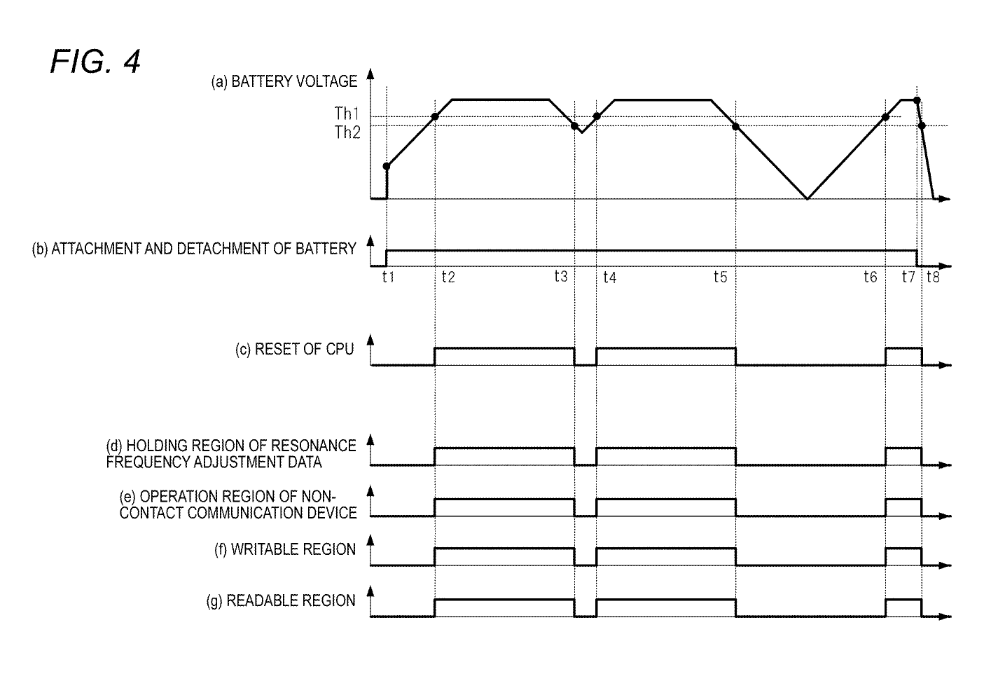

### MODE FOR CARRYING OUT THE INVENTION

A preferred embodiment for carrying out the invention will hereinafter be described in detail with reference to the drawings.

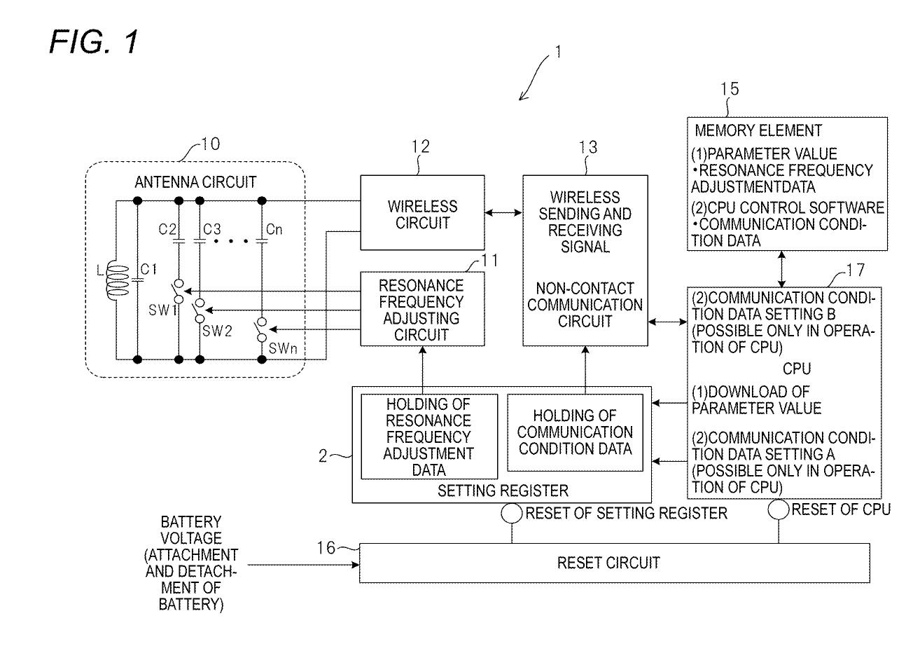

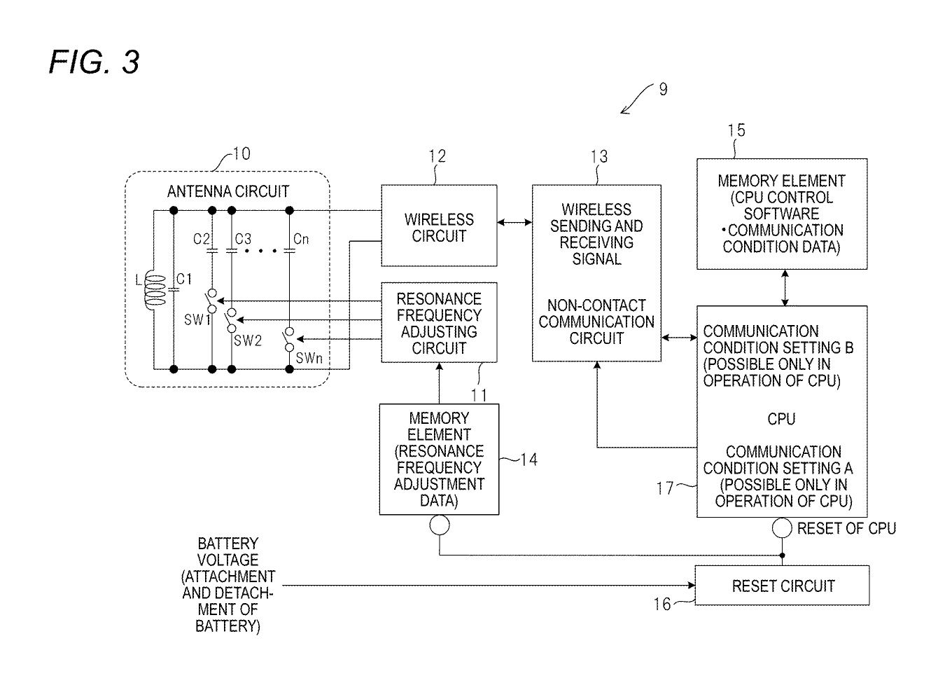

FIG. 1 is a block diagram showing a schematic configuration of a non-contact communication device according to one embodiment of the invention. In FIG. 1, the same numerals are assigned to the portions common to FIG. 3 and the explanation is omitted. A non-contact communication device 1 of the present embodiment has the same configuration as the conventional non-contact communication device 9 except that a setting register 2 is included instead of the memory element 14 of the conventional non-contact communication device 9 shown in FIG. 3. That is, the non-contact communication device 1 of the embodiment is configured to include the setting register 2, an antenna circuit 10, a resonance frequency adjusting circuit 11, a wireless circuit 12, a non-contact communication circuit 13, a memory element 15, a reset circuit 16, and a CPU 17.

The memory element 15 holds CPU control software (communication condition data) and also holds resonance frequency adjustment data which is a parameter value held by the memory element 14 of the conventional non-contact communication device 9. Since the memory element 14 as which EEPROM is mainly used is not used in the embodiment, cost can be reduced accordingly. Of course, the setting register 2 is more inexpensive than the memory element 14.

The CPU 17 reads out the CPU control software and the resonance frequency adjustment data which is the parameter value held in the memory element 15 before the CPU is reset, and transmits the software and the data to the setting register 2 via self. It is desirable that timing at which data is read from the memory element 15 is, for example, a point in time of activating the CPU 17. The CPU 17 is reset at a point in time when a battery voltage drops and falls below a threshold value Th2 (a first threshold value) of CPU reset release, and by downloading the resonance frequency adjustment data and the communication condition data into the setting register 2 before the CPU 17 is reset, non-contact communication can be conducted even when the CPU 17 is reset and becomes inactive. At this time, for example, data is not written on a ticket checker for the sake of security. That is, when data is written in an unstable state in which the battery voltage drops, erroneous data may be written and in order to avoid such a situation, writing of data is inhibited.

The setting register 2 is reset when the battery voltage falls below a threshold value Th3 (a second threshold value) greatly lower than the threshold value Th2 of CPU reset. When the battery voltage falls below the threshold value Th3, the setting register 2 is reset and data held by the setting register 2 is cleared. Consequently, the non-contact communication device 1 cannot be operated, and writing and readout by non-contact communication are disabled. These states continue until the battery voltage exceeds a threshold value Th1 of CPU reset release.

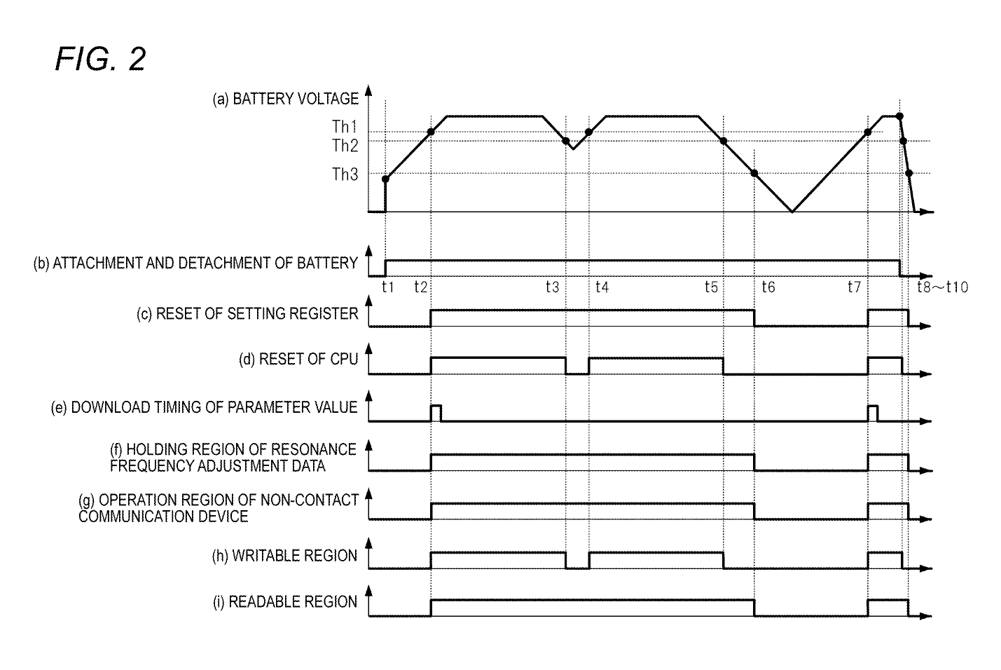

Next, an operation of the non-contact communication device 1 of the embodiment will be described with reference to a time chart shown in FIG. 2. In FIG. 2, (a), (b), (c), (d), (e), (f), (g), (h) and (i) show the battery voltage, a state of attaching and detaching a battery, a state of setting register reset/reset release, a state of CPU reset/reset release, download timing of a parameter value, a state of a holding region of the resonance frequency adjustment data, a state of an operation region of the non-contact communication device, a state of a writable region and a state of a readable region, respectively. The threshold value Th1 of CPU reset release, the threshold value Th2 of CPU reset and the threshold value Th3 for resetting the setting register 2 with respect to the battery voltage are respectively set in the non-contact communication device 1 of the embodiment. A magnitude relation between these threshold values is Th1>Th2>>Th3.

Now, when the battery is attached in a state that the battery (not shown) is detached, the present battery voltage is applied to the non-contact communication device 1 from time t1 at which the battery is attached. In the case of assuming that an AC adapter (not shown) is connected at this time, charging is started and the battery voltage rises. Thereafter, when the battery voltage exceeds the threshold value Th1 of the CPU reset release at time t2, reset of the setting register 2 is released at that point in time t2 and data can be written into the setting register 2. At the same time, the CPU reset is released and the CPU 17 becomes active. The CPU 17 downloads the resonance frequency adjustment data and the communication condition data from the memory element 15 to the setting register 2 at the point in time of activating the CPU 17. Consequently, the resonance frequency adjustment data and the communication condition data can be read from the setting register 2. Also, writing and read from data by non-contact communication are enabled at time t2.

Then, when the AC adapter is disconnected and the device is operated on the battery only and a load increases due to a telephone call etc. in operation on the battery and the battery voltage drops temporarily and falls below the threshold value Th2 of the CPU reset, the CPU is reset at the time t3 and the CPU 17 becomes inactive. At this time, the setting register 2 is not reset, so that non-contact communication can be conducted. However, data cannot be written for the sake of security. Thus, the resonance frequency adjustment data and the communication condition data are downloaded from the memory element 15 to the setting register 2 at the time of activating the CPU 17, so that the non-contact communication can be conducted even when the CPU is reset after the download. This state continues until the high load such as the telephone call is eliminated and the battery voltage exceeds the threshold value Th1 of the CPU reset release. When the high-load such as the telephone call is eliminated and the battery voltage exceeds the threshold value

Th1 of the CPU reset release, the CPU 17 becomes active at the time t4 and also writing of data by the non-contact communication is enabled.

Thereafter, when the battery voltage drops by battery discharging and falls below the threshold value Th2 of the reset, in a manner similar to the above, the CPU is reset at the time t5 and the CPU 17 becomes inactive. Also, writing of data by the non-contact communication is disabled. Then, when the battery voltage further drops and falls below the threshold value Th3 for resetting the setting register 2, the setting register 2 is reset at the time t6 and the contents of the setting register 2 are cleared and also the non-contact communication is not conducted and read from data is disabled.

Thereafter, when the AC adapter is connected and charging is again performed and the battery voltage exceeds the threshold value Th1 of the CPU reset release at time t7, reset of the setting register 2 is released and data can be written into the setting register 2. At the same time, the CPU reset is released and the CPU 17 becomes active. The CPU 17 downloads the resonance frequency adjustment data and the communication condition data from the memory element 15 to the setting register 2. Consequently, the resonance frequency adjustment data and the communication condition data can be read from the setting register 2. Also, writing and read from data by the non-contact communication are enabled.

On the other hand, when the battery is detached, immediately after the detached time t8, the battery voltage falls below the threshold value Th2 of the reset and in a manner similar to the above, the CPU is reset at the time t9 and the CPU 17 becomes inactive. Also, writing of data by the non-contact communication is disabled. Then, when the battery voltage further drops and falls below the threshold value Th3 for resetting the setting register 2, the setting register 2 is reset at the time t10 and the contents of the setting register 2 are cleared. Also, the non-contact communication is not conducted and read from data is disabled.

As described above, the non-contact communication device 1 of the embodiment includes the memory element 15 for storing the resonance frequency adjustment data and the communication condition data, and the setting register 2 capable of temporarily holding the resonance frequency adjustment data and the communication condition data, and the resonance frequency adjustment data and the communication condition data are downloaded from the memory element 15 to the setting register 2 before the CPU 17 is reset by a CPU reset signal, and a resonance frequency of the antenna circuit is adjusted using the data for resonance frequency adjustment downloaded to the setting register 2 in a state that the CPU 17 is reset by the CPU reset signal, so that the non-contact communication can be conducted even when the CPU 17 cannot be operated due to a drop in the battery voltage or a reset. Therefore, when a user passes through a ticket gate in the case of using trains, for example, by using a mobile telephone, the user can pass through the ticket gate even when a load increases temporarily due to a telephone call etc. and the battery voltage drops.

The invention has been described in detail with reference to the specific embodiment, but it is apparent to those skilled in the art that various changes or modifications can be made without departing from the spirit and scope of the invention.

The present application is based on Japanese patent application (patent application No. 2008-268899) filed on Oct. 17, 2008, and the contents of which are hereby incorporated by reference.

### INDUSTRIAL APPLICABILITY

The invention has an effect capable of conducting non-contact communication even when a control section cannot operate due to a drop in a battery voltage or a reset, and can be applied to a mobile telephone etc. capable of conducting the non-contact communication.

### DESCRIPTION OF REFERENCE NUMERALS AND SIGNS

1 NON-CONTACT COMMUNICATION DEVICE

2 SETTING REGISTER

10 ANTENNA CIRCUIT

11 RESONANCE FREQUENCY ADJUSTING CIRCUIT

12 WIRELESS CIRCUIT

13 NON-CONTACT COMMUNICATION CIRCUIT

15 MEMORY ELEMENT

16 RESET CIRCUIT

17 CPU

1. A non-contact communication device which is driven by a battery and conducts non-contact communication by adjusting a resonance frequency of an antenna circuit using data for resonance frequency adjustment, the non-contact communication device comprising:
a memory section that stores the data for resonance frequency adjustment;
a control section that is reset by a first reset signal issued at the time when a voltage of the battery falls below a first threshold value;
a register section that temporarily holds data and is reset by a second reset signal issued at the time when the voltage of the battery falls below a second threshold value lower than the first threshold value; and
the antenna circuit whose resonance frequency is adjusted by the data temporarily held in the register section,
wherein the control section downloads the data for resonance frequency adjustment from the memory section to the register section as the data before the control section is reset by the first reset signal, and the resonance frequency of the antenna circuit is adjusted using the data for resonance frequency adjustment previously downloaded to the register section in a state that the control section is reset by the first reset signal.

2. The non-contact communication device according to claim 1, wherein the antenna circuit has a coil, a plurality of capacitors and a plurality of switches respectively connected to the plurality of capacitors; and
wherein the resonance frequency of the antenna circuit is adjusted by turning on and off the plurality of switches using the data for resonance frequency adjustment.
